(19) United States
(12) Patent Application Publication
(10) Pub. No.: US 2025/0162339 A1
(43) Pub. Date: May 22, 2025

(54) DIRECT THERMAL INK WITH HEAT RETENTION FOR ENHANCED IMAGING

(71) Applicant: Temptime Corporation, Morris Plains, NJ (US)

(72) Inventors: Brian S. HUFFMAN, Belle Mead, NJ (US); Marielle K. SMITH, Parlin, NJ (US); Thi N. DO, West Orange, NJ (US)

(73) Assignee: Temptime Corporation, Morris Plains, NJ (US)

(21) Appl. No.: 18/511,871

(22) Filed: Nov. 16, 2023

(51) Int. Cl. B41M 5/30; B41M 5/323; B41M 5/382; B41M 5/41

(52) U.S. Cl. CPC B41M 5/305; B41M 5/323; B41M 5/38271; B41M 5/41

(57) ABSTRACT

Direct thermal inks with heat retention are disclosed herein. An example direct thermal ink includes a thermal printable media, including a substrate, and a composite including a thermochromic material and a latent heat material; wherein the composite is coupled to the substrate and a color state of the thermochromic material changes responsive to the thermochromic material exceeding a predetermined temperature threshold; wherein the latent heat material melts responsive to an applied heat on the thermal printable media during a thermal printing process and, after the applied heat ceases, to release a stored portion of the applied heat as the latent heat material re-solidifies such that the composite remains in excess of the predetermined temperature threshold thereby increasing an amount of change in the color state of the thermochromic material in response to the applied heat during the thermal printing process.

### BACKGROUND

In the field of thermal printing, substandard heat exposure to the direct thermal ink often results in impaired or reduced color development in the final thermal printed product. Substandard heat exposure can result from different darkness settings (thermal printhead heat), imprecise printhead contact, low ambient temperature, inconsistent power delivery, and a host of other complications.

### SUMMARY

In an embodiment, the present disclosure provides a thermal printable media, including a substrate, and a composite including a thermochromic material and a latent heat material (LHM). The composite is coupled to the substrate and a color state of the thermochromic material changes responsive to the thermochromic material exceeding a predetermined temperature threshold. The LHM melts responsive to an applied heat on the thermal printable media during a thermal printing process and, after the applied heat ceases, releases a stored portion of the applied heat as the LHM re-solidifies such that the composite remains in excess of the predetermined temperature threshold thereby extending a length of time the thermochromic material remains in excess of the predetermined temperature threshold and increasing an amount of change in the color state of the thermochromic material in response to the applied heat during the thermal printing process.

In a variation of this embodiment, the LHM is a contained in a microcapsule.

In a variation of this embodiment, the LHM remains microencapsulated throughout a duration of the thermal printing process.

In a variation of this embodiment, a melting point of the LHM is lower than a temperature of the applied heat.

In a variation of this embodiment, a melting point of the composite is lower than a temperature of the applied heat.

In a variation of this embodiment, the LHM is chemically inert with respect to the thermochromic material.

In a variation of this embodiment, the stored portion of the applied heat in the LHM is sufficient to maintain the thermochromic material in excess of the predetermined temperature threshold for a period in a range from 0.01-5 seconds after the applied heat ceases.

In a variation of this embodiment, the predetermined temperature threshold is in a range 85 degrees C. to 92 degrees C.

In a variation of this embodiment, a duration of a thermal printing process required to yield an optical density of at least 0.25 on the thermal printable media is in a range of 5% less to 50% less than a duration of the thermal printing process required to yield an optical density of at least 0.25 on a similar thermal printable media that does not contain the LHM.

In a variation of this embodiment, the composite scores in a range of 1.8 to 2.5 on the Thermochromic Print Density Index.

In a variation of this embodiment, the composite scores at least 2.0 on the Thermochromic Print Density Index.

In a variation of this embodiment, the thermochromic material comprises a leuco dye.

In a variation of this embodiment, the substrate comprises a material selected from group consisting of: paper, paperboard, cardboard, cotton, linen, jute, ramie, industrial hemp or rayon, polyamide, polyester, polyacrylate, polyurethanes or vinyl-based fibers, blended fibrous substrates based on cellulosic and non-cellulosic fibers; polymeric resin; composites of polymeric resins with cellulosic or non-cellulosic fibrous material and combinations thereof.

In a variation of this embodiment, the substrate is paper.

In a variation of this embodiment, the thermal printable media is disposed in a roll, about a spool, or in a fan fold stack.

In a second embodiment, the present disclosure provides a thermochromic composite, including a leuco dye and a latent heat material. The leuco dye begins to change a color state when the thermochromic composite exceeds a predetermined temperature threshold in response to an applied heat from a heat source. The LHM melts in response to the applied heat, and is configured to retain and release at least a portion the applied heat as it re-solidifies, increasing a time that a temperature of the thermochromic composite remains above the predetermined temperature threshold the applied heat has ceased to be applied.

In a variation of this embodiment, the LHM is contained in a microcapsule.

In a variation of this embodiment, a proportion of the latent heat material in the thermochromic composite is in a range of 5 percent by weight to 50 percent by weight.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed devices, methods and apparatuses, and explain various principles and advantages of those embodiments.

FIG. 1 illustrates a thermal printable media, configured as a sheet, according to embodiments of the present disclosure.

FIG. 2 illustrates a thermal printable media, configured as a roll, according to embodiments of the present disclosure.

FIG. 3 illustrates a thermal printable media, configured as a roll of a web of thermally printable adhesive labels, according to embodiments of the present disclosure.

FIG. 4 illustrates results of Experiment 1, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the description with details that will be readily apparent to those of ordinary skill in the art having the benefit of the description herein.

### DETAILED DESCRIPTION

The thermochromic composite of the present disclosure includes a microencapsulated latent heat material as an additive to a thermal ink. Generally, the term latent heat material (LHM) is used to categorize a group of phase-change materials having high latent heats of fusion (LHF), and release or absorb quantities of energy during phase transitions that are useful for heating and cooling. LHMs require a large energy input (or produce a large energy output) when undergoing a phase change, such that energy can be stored in the material between phases. For example, a LHM having a high LHF requires a substantial energy input to transition from the solid phase to the liquid phase (e.g. melt), as the energy threshold required to break the bonds between the molecules of the LHM in a solid phase is considerable. Once the energy (heat) input is exceeds the threshold, the LHM becomes a liquid. As the LHM cools, the LHM begins to solidify, resulting in the exothermic dispersal of energy previously used to melt the LHM.

According to some embodiments, the thermal ink with which the LHM is combined to form the thermochromic composite includes three primary agents, a color former, a color developer, and a melting agent. The melting agent may include a phase-change material which, in the solid phase, acts as a structural matrix in which the color former and color developer are disposed. In some examples, the melting agent may further include resins, waxes, and solvents. As heat is applied (e.g. during a thermal printing process), the melting agent transitions to a liquid phase and becomes (or releases) a solvent for the color former and color developer. As the color former and color developer become solubilized in the solvent, a chemical reaction between the color former and color developer is facilitated. The reaction results in a color state change perceived as the “development” of the ink. The chemical reaction and change in color state continues to occur until either the color former or color developer is exhausted, or the melting agent solidifies (as a result of cooling) such that the remaining unreacted color former and color developer are once again immovably held in the structural matrix of the melting agent.

In thermal printing applications, an outcome in which the chemical reaction stops due to exhaustion of the color former and color developer is preferable to cessation due to solidification; as exhaustion corresponds to a more complete reaction and color state change, e.g. development of the ink. In many cases, the complete reaction does not occur, as solidification occurs prior to the reaction reaching an exhaustion point. An immediate solution would be to apply more heat to the ink, ensuring the melting agent remains liquid and facilitating the completion of the reaction. Unfortunately, this solution is often impractical, requiring additional energy input and decreasing output rates in practical application.

The addition of LHMs to the thermal ink creates a thermochromic composite in which the melting agent remains in a liquid state for a greater duration of time. By selecting a LHM having a melting point similar to that of the thermal ink, the available reaction time may be extended without increasing the overall heat input. As heat is applied to the thermochromic composite (e.g. as in a thermal printing process), the LHM retains heat from the heat source (e.g. thermal printhead) as the LHM transitions from the solid phase to the liquid phase. In some examples, the heat retained by the LHM from the heat source is heat that would otherwise quickly dissipate from a thermal ink alone. In the thermochromic composite, the thermal ink melts with the LHM, but has a lower capacity for storing energy than the LHM. While the thermochromic composite is in the liquid phase, the color former and color developer undergo the chemical reaction and subsequent color state change. As the applied heat ceases, the thermochromic composite begins to release heat to the surroundings as it cools and comes to thermal equilibrium. The LHM, having a large quantity of retained heat, releases the retained heat into the thermochromic composite, which increases duration of time that the thermochromic composite remains above the solidification temperature, and thus in a liquid state, subsequently increasing the amount of color state change resulting from the reaction.

In some examples the LHM is microencapsulated, e.g. elements of the LHM are individually contained in microcapsules, and remains microencapsulated throughout the duration of the thermal printing and color development process. In this manner, the LHM is chemically inert with respect to the thermal ink. The process of the LHM absorbing and releasing heat within the thermochromic composite does not have a chemical effect on the ink, either as a solvent, a reactant or otherwise. The chemical independence of the LHM is beneficial, as it precludes potential print problems that non-microencapsulated LHM materials may introduce. Non-microencapsulated LHMs may prevent or impair the chemical reaction that drives the color state change. Moreover, a chemical reaction between a reactive LHM and a thermal ink may prevent the thermochromic composite from re-solidifying entirely, resulting in smearing and smudging on the final printed product. As such, the non-reactivity of the microencapsulated LHM is essential to the function of the thermochromic composite.

According to some embodiments, the LHM may include waxes, paraffin, polymeric compounds, hydrated salt compounds, molten salts and combinations thereof. The microcapsules in which the LHM is contained may be formed from silicon, silicon derivatives, polymers, or plastics. In some examples, the microencapsulated LHM is a paraffin wax encapsulated in a SiO₂ shell. An example of a publicly available microencapsulated LHM material is Thermoball by Insilico Co., LTD.

In some examples the LHM is variably configurable such that the thermochromic composite can be tuned melt, and thus to develop color, at different temperatures, allowing for compatibility with a plurality of printers and print settings, ideally without suffering decreases in print quality. Furthermore, the thermochromic composite may be optimized towards print settings with lower temperatures, and subsequently lower power consumption requirements, facilitating savings in energy costs, as well as operating under more green/environmentally friendly conditions.

According to some embodiments, the melting points of the thermochromic composite, the LHM alone, and the thermal ink alone, are lower than the temperature of the applied heat of the printing process. In some embodiments, the melting point of the thermochromic composite may be tuned to have a melting point in the range of 30 degrees C. to 170 degrees C.

According to some embodiments, the thermal ink may include additives for glossiness, texture, and other visual qualities, or for thermal stability. Some examples of publicly available thermal inks are IQ color ink by ARMOR-IIMAK, Thermosil by Siltech LTD, LCR by Kromagen®, Irreversible inks by NanoMatriX®, and UMC Irreversible inks.

In some examples, the thermochromic composite is a mixture including a leuco dye based thermochromic ink, the proportion of which may be in a range of 20 percent to 90 percent by weight, a LHM in a proportion in a range of 5 percent to 50 percent by weight, and added water in a proportion in a range of 0 percent to 50 percent by weight.

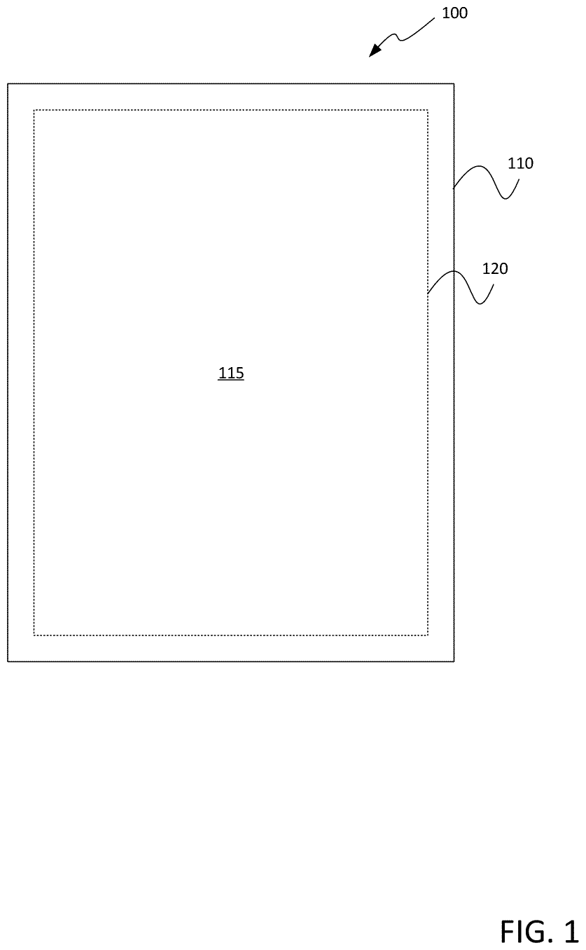

FIG. 1 illustrates a sheet 100 of thermally printable material, including a substrate 110 and thermochromic composite 115 (e.g. any of the thermochromic composites described herein) disposed in a printable region 120. In some examples, the substrate 110 is a paper product, such as paper, paperboard, cardboard, cotton, linen, jute, ramie, industrial hemp or rayon, polyamide, polyester, polyacrylate, polyurethanes or vinyl-based fibers, blended fibrous substrates based on cellulosic and non-cellulosic fibers; polymeric resin; and composites of polymeric resins with cellulosic or non-cellulosic fibrous material; and combinations thereof. The thermally printable region 120 is an area of the substrate 110 to which the thermochromic composite 115 has been coupled. In various embodiments, the thermochromic composite 115 may be, via various methods, imbued into a fibrous matrix of the substrate 110. In other examples, the thermochromic composite 115 may be disposed in a coating layer on a surface of the substrate 110. In some examples, the thermochromic composite is disposed on the substrate 110 in a layer having a thickness in the range of 1 micron to 50 microns.

The thermochromic composite 115 is distributed in sufficient volume across substrate 110 to effectively react and exhibit a readily observable color state change when exposed to an applied heat, e.g. a thermal printing process.

The illustrated embodiment of FIG. 1 shows a thermally printable sheet 100 having dimensional ratios consentient with a letter size sheet; however the present disclosure contemplates embodiments in which the thermal printable media includes any side length ratio. Further contemplated by the present disclosure are embodiments in which the printable region 120 of the sheet 100 occupies the entirety of the surface of substrate 110, asymmetric portions of substrate 110, and any configurations of non-printable margins on sheet 100, as well as embodiments where both faces of the substrate 110 include a printable region 120.

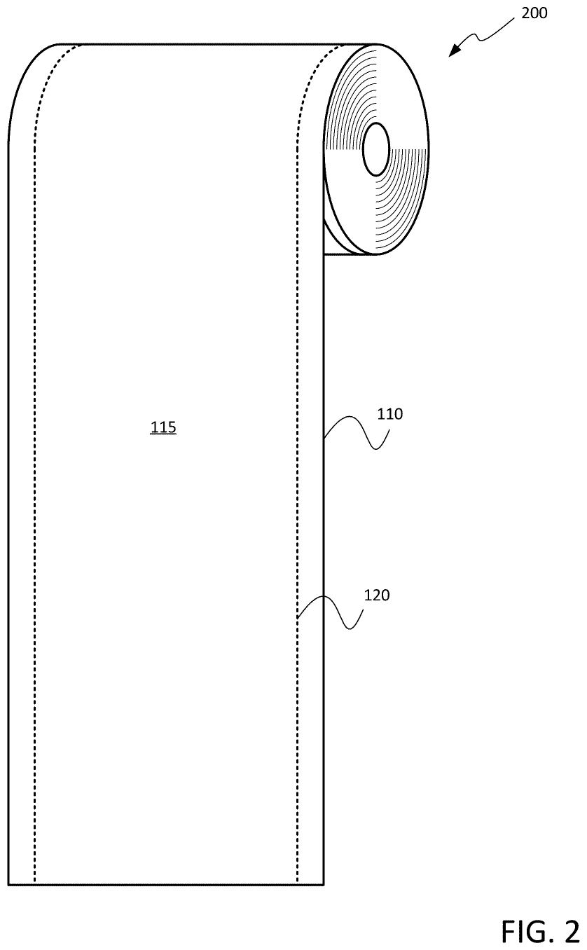

FIG. 2 illustrates a roll 200 of thermally printable material, including a substrate 110 and a thermochromic composite 115 disposed in a printable region 120. The roll 200 is configure as a continuous strip of substrate 110 wound about a spool. According to some embodiments, the roll 200 of thermally printable material is suited for applications with thermal roll printers, for printing media such as receipts, tickets, and other forms of media of constant width and variable length. Although illustrated as having non-printable margins, this disclosure contemplates embodiments where the printable region 120 extends to the edge of the substrate 110, as well as embodiments where both faces of the substrate 110 include a printable region 120.

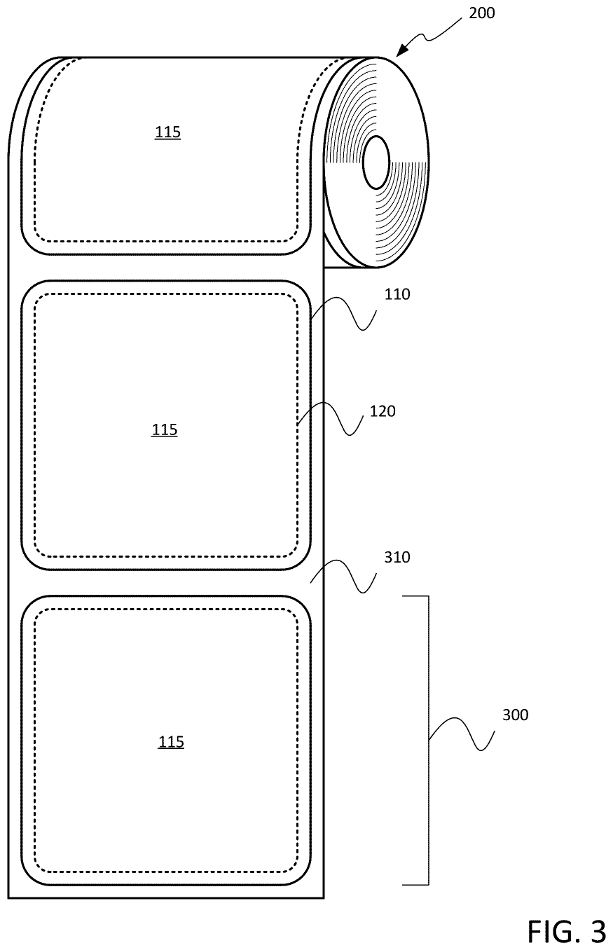

FIG. 3 illustrates a roll 200 of thermally printable labels 300, including a substrate 110, thermochromic composite 115 disposed in printable regions 120, and a liner 310. The roll 200 of thermally printable labels 300 is configured as a web of labels 300, temporarily adhered to a liner 310, which, in some examples, includes a release surface such that the labels 300 may be readily removed for application to a host product. According to some embodiments, the labels 300 include an adhesive backing on the surface of the substrate 110 opposite the printable region 120, by which the labels are temporarily adhered to the liner, and then to the host product. Although illustrated as having non-printable margins, this disclosure contemplates embodiments wherein the printable region 120 of each label 300 extends to the edges of the substrate 110. Embodiments wherein the web of labels is configured as a fan fold stack are further included in the scope of the instant disclosure.

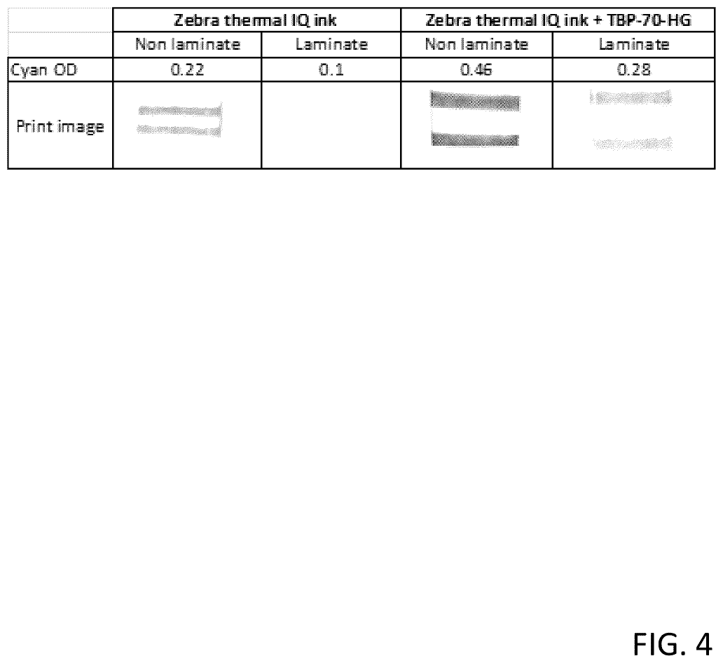

FIG. 4 illustrates experimental results according to Experiment 1, discussion of which may be found in the Examples section below.

Using the data collected in Experiment 1 (see Examples section below), a Thermochromic Print Density Index is defined herein. The Thermochromic Print Density Index is used to measure the effect of an additive on the optical density of a thermally printed product in suboptimal printing conditions. The index is defined as:

$$I = \frac{C}{B}$$

Wherein I represents the index score of a sample, Bis the optical density of the thermal ink with no additive, and C is the optical density of the thermochromic composite (e.g. thermal ink with the additive). The ratio of C/B is configured such that an improvement in print density results in a higher score. The index is standardized such the samples are heated to a temperature of 90 degrees C. for a period of 0.6 seconds, which is designed to emulate suboptimal print conditions. By definition, the score of a thermal ink without an additive is 1.

According to some embodiments, the various embodiments of the thermochromic composite score in the range of 1.1 to 2.5 on the Thermochromic Print Density Index.

In some examples, an increased index score correlates to a reduction in the required duration of a thermal printing process to achieve a predetermined optical density. According to some embodiments, the thermochromic composite can reduce the duration of a printing process required to yield an OD of 0.25 on the thermal printable media by about 5%, by about 10%, by about 15%, by about 20%, by about 25%, by about 30%, by about 35%, by about 40%, by about 45%, or by about 50%, relative to a similar thermal printable media that does not include a LHM.

### Example

### Experimental Details

An experiment was performed to find the cyan optical density (OD) of laminated and non-laminated samples of the thermochromic composite with the LHM, and control samples of the thermal ink alone. Experiment 1 tests a thermochromic composite including TPB-70-HG, which is a LHM material, blended with Zebra Thermal Ink IQ Black (IQ Black Ink), which is a leuco dye based ink. The Thermochromic Composite is formulated with weight ratios of 15% LHM, 70% IQ Black Ink, and 15% added water. A Meyer rod DIV18 was used to coat the inks onto Fasson Primax 250 propylene film and the coating was air dried for 24 hours. The dried coating was depressurized for 5 seconds by using JORESTECH Vacuum Packaging Machine Model VAC-275T and seal with low heat for 0.6 sec.

### Results

TABLE 1
Cyan OD of Thermochromic Composite
with LHM vs IQ Black Ink

| | Thermochromic Composite | IQ Black Ink |
|---|---|---|
| Laminate | 0.28 | 0.1 |
| Non-Laminate | 0.46 | 0.22 |

Table 1 shows that the thermochromic composite yields a higher cyan OD at suboptimal print conditions than the thermal ink alone. FIG. 4 includes images of the developed samples, where the distinction between the samples is plainly observable. This indicates that the addition of the LHM improves the color development of the thermochromic composite at low print temperatures.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed devices, methods and apparatuses are defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A thermal printable media, comprising:
a substrate; and
a composite comprising a thermochromic material and a latent heat material (LHM);
wherein the composite is coupled to the substrate;
wherein a color state of the thermochromic material changes responsive to the thermochromic material exceeding a predetermined temperature threshold; and
wherein the LHM is configured to melt responsive to an applied heat on the thermal printable media during a thermal printing process and, after the applied heat ceases, to release a stored portion of the applied heat as the LHM re-solidifies extending a length of time the thermochromic material remains in excess of the predetermined temperature threshold and increasing an amount of change in the color state of the thermochromic material in response to the applied heat during the thermal printing process.

2. The thermal printable media of claim 1, wherein the LHM is a contained in a microcapsule.

3. The thermal printable media of claim 2, wherein the LHM remains microencapsulated throughout a duration of the thermal printing process.

4. The thermal printable media of claim 2, wherein the microencapsulated LHM is chemically inert with respect to the thermochromic material.

5. The thermal printable media of claim 1, wherein a melting point of the LHM is lower than a temperature of the applied heat.

6. The thermal printable media of claim 1, wherein a melting point of the composite is lower than a temperature of the applied heat.

7. The thermal printable media of claim 1, wherein the stored portion of the applied heat in the LHM is sufficient to maintain the thermochromic material in excess of the predetermined temperature threshold for a period in a range from 0.01-5 seconds after the applied heat ceases.

8. The thermal printable media of claim 1, wherein the predetermined temperature threshold is in a range 85 degrees Celsius (C) to 92 degrees C.

9. The thermal printable media of claim 1, wherein a duration of a thermal printing process required to yield an optical density of at least 0.25 on the thermal printable media is in a range of 5% less to 50% less than a duration of the thermal printing process required to yield an optical density of at least 0.25 on a similar thermal printable media that does not contain the LHM.

10. The thermal printable media of claim 1, wherein the composite scores in a range of 1.8 to 2.5 on the Thermochromic Print Density Index.

11. The thermal printable media of claim 1, wherein the composite scores at least 2.0 on the Thermochromic Print Density Index.

12. The thermal printable media of claim 1, wherein the thermochromic material comprises a leuco dye.

13. The thermal printable media of claim 1, wherein the substrate comprises a material selected from group consisting of: paper, paperboard, cardboard, cotton, linen, jute, ramie, industrial hemp or rayon, polyamide, polyester, polyacrylate, polyurethanes or vinyl-based fibers, blended fibrous substrates based on cellulosic and non-cellulosic fibers; polymeric resin; composites of polymeric resins with cellulosic or non-cellulosic fibrous material and combinations thereof.

14. The thermal printable media of claim 1, wherein the substrate is paper.

15. The thermal printable media of claim 1, wherein the thermal printable media is disposed in a roll, about a spool, or in a fan fold stack.

16. The thermal printable media of claim 1, wherein the substrate is temporarily adhered to a liner.

17. A thermochromic composite, comprising:
a leuco dye; and
a latent heat material (LHM);
wherein the leuco dye begins to change a color state when the thermochromic composite exceeds a predetermined temperature threshold in response to an applied heat from a heat source; and
the LHM melts in response to the applied heat, and is configured to retain and release at least a portion the applied heat as it re-solidifies, increasing a time that a temperature of the thermochromic composite remains above the predetermined temperature threshold the applied heat has ceased to be applied.

18. The thermochromic composite of claim 17, wherein the LHM is contained in a microcapsule.

19. The thermochromic composite of claim 17, wherein a proportion of the LHM in the thermochromic composite is in a range of 5 percent by weight to 50 percent by weight.
